(19) United States
(12) Patent Application Publication
(10) Pub. No.: US 2026/0273984 A1
(43) Pub. Date: Sep. 17, 2026

(54) GREETING CARD FOR AUTOMATED PRINTING

(71) Applicant: Hallmark Cards, Incorporated, Kansas City, MO (US)

(72) Inventors: Orlanda Lacy, Kansas City, MO (US); Susan Priscilla Crilley, Overland Park, KS (US)

(21) Appl. No.: 19/680,493

(22) Filed: May 18, 2026

Related U.S. Application Data
(62) Division of application No. 17/834,819, filed on Jun. 7, 2022.

(51) Int. Cl. B42D 15/04; B31D 1/00; B31D 5/04; B41J 3/28; B42D 15/02; G09F 1/04

(52) U.S. Cl. CPC B42D 15/042; B31D 1/0075; B31D 1/0081; B31D 5/04; B41J 3/28; B42D 15/027; G09F 1/04; B42P 2241/20; B42P 2241/22

(57) ABSTRACT

This application is related to a greeting card that is conducive to automated printing, as well as methods and systems for printing on the greeting card. For example, the greeting card can include a three-dimensional (3D) card element that is containable, when the card is being printed, between a first panel of the greeting card and a protective panel of the greeting card. In addition, the greeting card can include a second panel for receiving a printed graphic (e.g., text, letters, numbers, pictures, symbols, etc.).

### CROSS-REFERENCE TO RELATED APPLICATIONS

This application claims priority to and is a Divisional of U.S. patent application Ser. No. 17/834,819, filed on Jun. 7, 2022, which is incorporated herein by reference in its entirety.

### BACKGROUND

Greeting cards can have various elements that contribute to the card-opening experience. For example, some greeting cards can include a message that is customized from the card giver to the card recipient. In addition, greeting cards can include additional card elements that are contained between card panels (e.g., pop-up structures, pockets, inserts, gift cards, etc.) that are revealed or accessible when the card panels are opened. In addition, printers can be equipped with components for feeding a greeting card and printing a graphic in a designed position.

### DETAILED DESCRIPTION OF DRAWINGS

The present systems and methods related to a greeting card are described in detail below with reference to these figures.

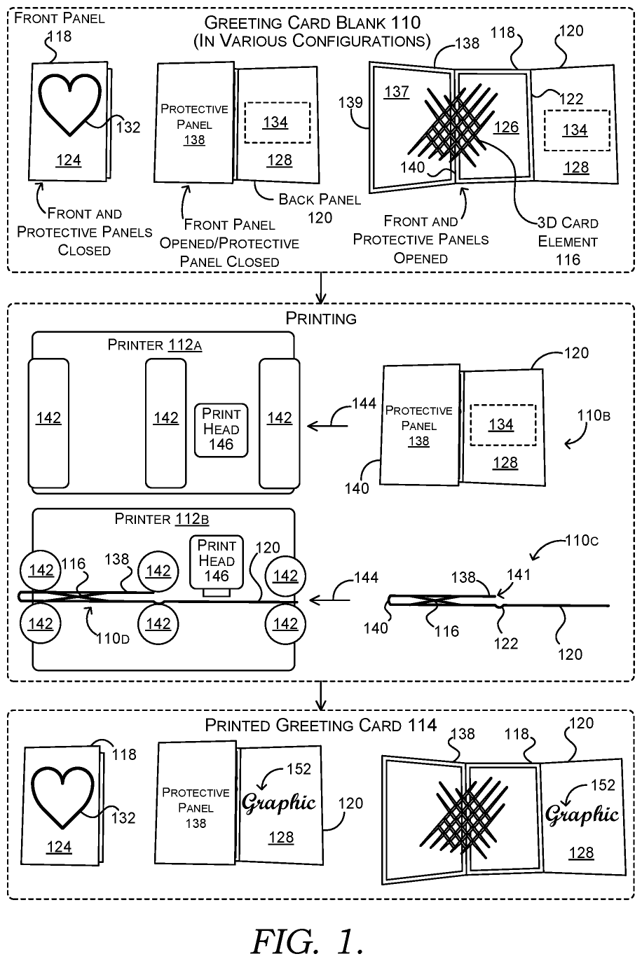

FIG. 1 depicts a greeting card with a three-dimensional (3D) card element, the greeting card being conducive to printing, in accordance with examples of this disclosure.

FIG. 1B depicts a schematic of an alternative printing orientation for a greeting card, in accordance with examples of this disclosure.

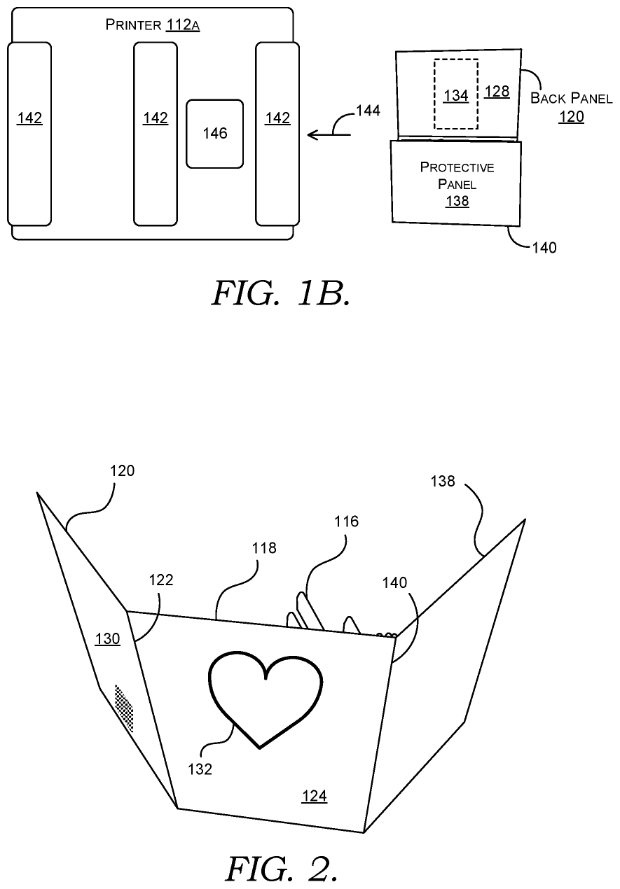

FIG. 2 depicts another view of a greeting card depicted in FIG. 1, in accordance with examples of this disclosure.

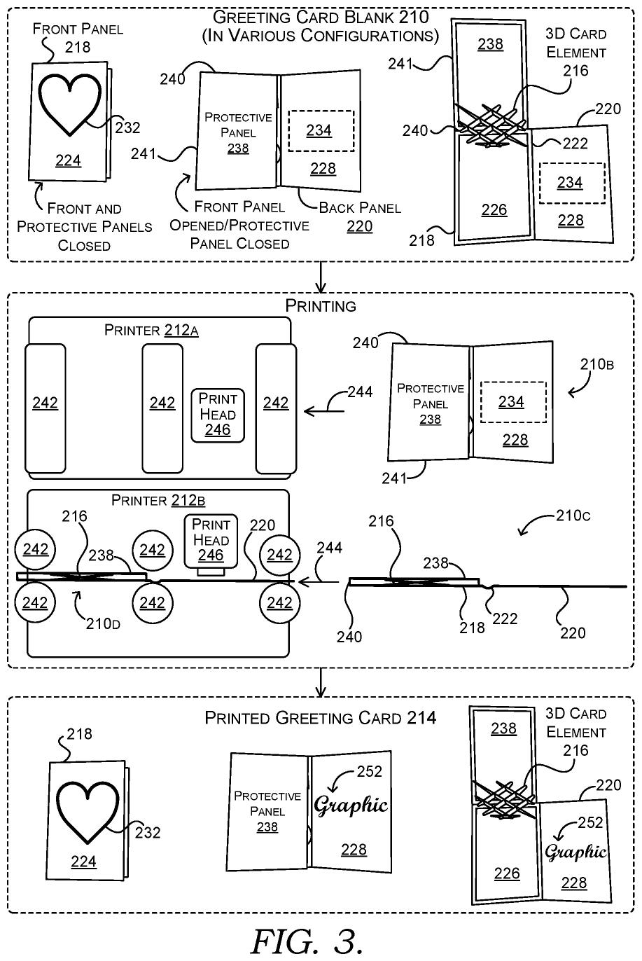

FIG. 3 depicts another greeting card with a three-dimensional (3D) card element, the greeting card being conducive to printing, in accordance with examples of this disclosure.

FIG. 3B depicts a schematic of an alternative printing orientation for a greeting card, in accordance with examples of this disclosure.

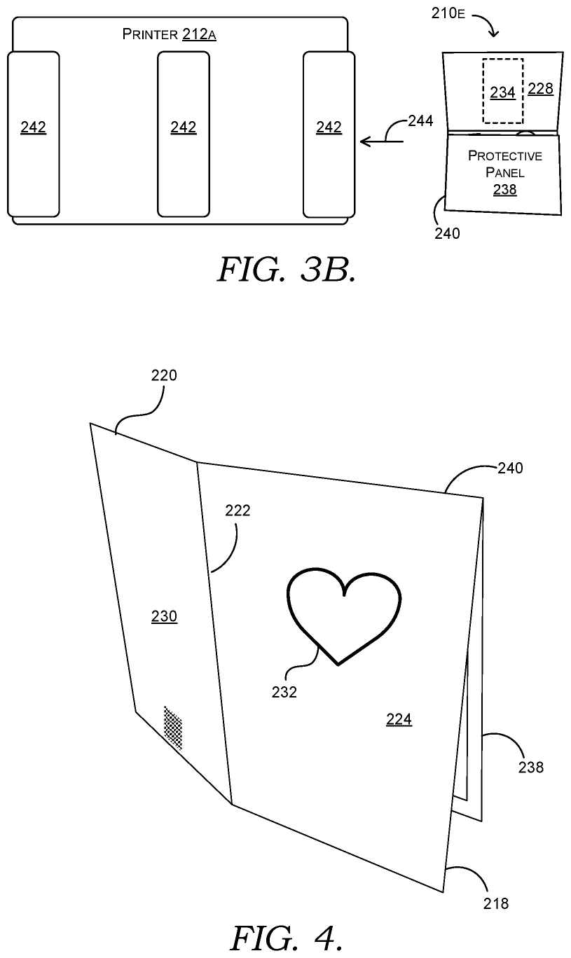

FIG. 4 depicts another view of a greeting card depicted in FIG. 3, in accordance with examples of this disclosure.

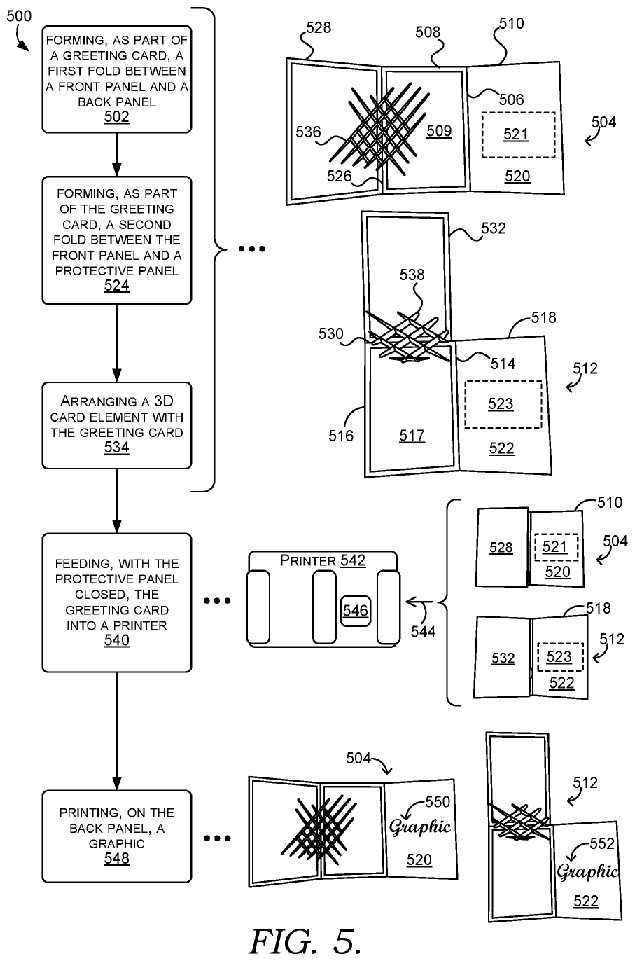

FIG. 5 depicts a flow diagram associated with a method for printing a greeting card, in accordance with examples of the present disclosure.

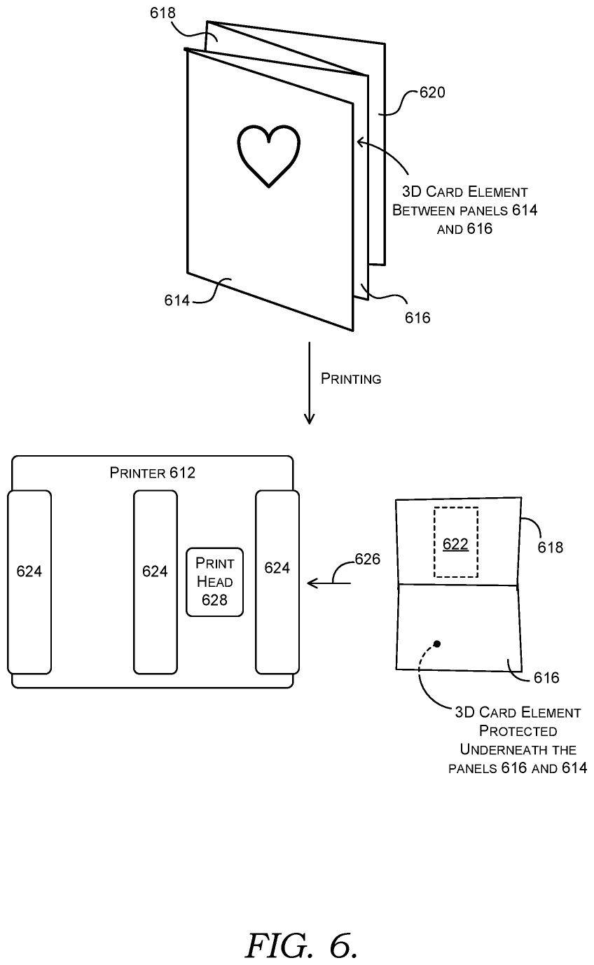

FIG. 6 depicts a greeting card that can include a 3D card element and is conducive to automated printing, in accordance with examples of the present disclosure.

### DETAILED DESCRIPTION

This detailed description is related to a greeting card that is conducive to automated printing. For example, the greeting card can include a three-dimensional (3D) card element (e.g., pop-up structure, pocket, insert, gift card, etc.) that is containable between a front panel of the greeting card and a protective panel of the greeting card. In addition, the greeting card can include a back panel for receiving a printed graphic (e.g., text, letters, numbers, pictures, symbols, etc.), and in some examples, the graphic can represent a copy of a digital image provided by a purchaser (e.g., retail customer) of the greeting card or by another entity (e.g., card retailer, card manufacturer, etc.). In at least some examples, the arrangement of the panels (e.g., the 3D card element between the front panel and the protective panel and the back panel for receiving a customized graphic) is conducive to automated printing. For example, when the greeting card is fed into a printer, the front panel and protective panel can operate to reduce a likelihood of interference between the 3D card element and the printer components (e.g., rollers, guides, etc.), and the back panel, which is not layered or stacked with the 3D card element, can provide a relatively even and smooth surface on which the graphic can be printed.

Having described some general examples of what this disclosure is related to, some more specific examples are now provided. In some instances, automated printing and other automated operations can be used when manufacturing a greeting card. Automated printing can be executed at different stages of the card manufacturing process. For instance, in some examples, automated printing can be used after a greeting card has been at least partially assembled (e.g., partially assembled, mostly assembled, fully assembled, etc.). For example, a greeting card manufacturer, retailer, or supplier might want to preassemble a batch or array of cards with the same features (e.g., panel arrangement and 3D card element) and then selectively apply a printed graphic (e.g., representing a digital image provided by the manufacturer, by a card purchaser or retail customer, or by another source) onto any card in the batch or array. In some examples, cards that are at least partially assembled can include card elements that can affect printing operations. For example, an at least partially assembled card can include card features (e.g., panel edges, protrusions, tabs, etc.) that can interfere with printing components (e.g., feeders, rollers, guides, etc.). In addition, an at least partially assembled card can include surfaces that are uneven or otherwise affect print quality.

In an example of the present disclosure, a greeting card blank (e.g., at least partially assembled card) can include a panel structure and a 3D card element, and the greeting card blank can be automatedly printed on, regardless of potential uneven surfaces resulting from the 3D card element. For example, the greeting card blank can include a front panel and a back panel that are hingedly coupled to one another along a first fold, such that the front panel and the back panel are movable (via hinging or rotating on the first fold) between a closed configuration and an open configuration. In addition, the front panel can include a outer card face that forms a front of the greeting card and that can include a graphic (e.g., text, numbers, letters, pictures, symbols, etc.), and the back panel can form a back of the greeting card blank and can include an inner card surface for having a graphic printed thereon. That is, the inner card surface can have a portion on which a graphic can be printed, such as when the greeting card blank is fed into an automated printer.

In at least some examples, the greeting card blank can include a protective panel that is hingedly coupled to the front panel by a second fold, such that the front panel and the protective panel are movable (via hinging or rotating on the second fold) between a closed configuration and an open configuration. In addition, the 3D card element is positioned between the first panel and the protective panel when they are in the closed configuration. For example, the 3D card element can be attached to at least one of the first panel and the protective panel and can be collapsed or otherwise contained between the first panel and the protective panel when they are closed. In examples, the second fold can be oriented parallel with the first fold, perpendicular with the first fold, or any of a variety of other orientations with respect to the first fold.

In at least some examples, a graphic can be printed on the back panel of the greeting card blank, while reducing the likelihood that the 3D card element is damaged or interferes with printer components. In addition, the back panel of the greeting card, which can be relatively separate from the 3D card element, can provide an even and flat surface on which a graphic can be printed. For instance, when the front panel and the back panel are open and the front panel and the protective panel are closed, the 3D card element is protected from interference and the back panel is made available for printing. In addition, the front panel and the protective panel can be fed, before the back panel, into the automated printer, which can increase the likelihood that the protective panel remains in a closed configuration. In examples, once the card is fed into position, the printer can print a graphic on the back panel, and because the back panel is independent of the 3D card element (e.g., the back panel can be a single layer of material), the back panel can provide a relatively flat and uniform surface on which to print. In examples, the graphic can include, among other things, text, letters, numbers, symbols, pictures, etc. In addition, the graphic can include a representation of a digital image provided by a customer purchasing the card from a greeting card retailer.

Referring now to FIG. 1, FIG. 1 depicts one or more systems associated with a greeting card and with components or operations for printing on the greeting card. For example, the system(s) include a greeting card blank 110, a printer 112 for printing on the greeting card blank 110, and a printed greeting card 114 that has been printed on via the printer 112 (e.g., the printed greeting card 114 can be the greeting card blank 110 at a later time, after being printed on). In accordance with examples of the present disclosure, the greeting card blank 110 includes 3D card element 116 (e.g., a pop-up structure) and various features that facilitate printing on the greeting card blank 110, regardless of potential uneven surfaces in the greeting card blank 110 that can result from the 3D card element or potential interference between the 3D card element 116 (or other parts of the card) and the printer. Absent examples of the present disclosure, it can be more difficult to print on a card that includes a 3D card element (e.g., due to uneven surfaces, interference between the pop-up structure and printer components, etc.), and subject matter described in this disclosure can facilitate better printing on the card 110 with the 3D card element 116. In addition, examples described in this disclosure can protect the greeting card blank 110 and the 3D card element 116 from potential damage during the printing process (e.g., damage from the printer feeder components).

As used herein, the term “blank” describes a greeting card that is at least partially assembled and that includes at least a portion configured to receive additional card elements (e.g., surface ornamentation). For example, multiple blanks can be copies of one another and any of the blanks can be customized, such as by adding a graphical element. The term blank does not necessarily mean that the greeting card does not include any graphics or other surface ornamentation, which can be common across a set of blanks sharing common design features. In some examples, the greeting card blank 110 can include a front panel 118 and a back panel 120 that are hingedly coupled to one another along a first fold 122. As used herein, a “panel” can include a variety of different materials conventionally used to construct greeting cards, such as paper and cardstock of various weights. The front panel 118 and the back panel 120 are movable between a closed configuration, in which the front panel 118 and back panel 120 are folded (along the first fold 122) towards one another, and an open configuration, in which the front panel 118 and the back panel 120 are splayed (via the first fold 122) apart and away from one another. In addition, the front panel 118 can include a first outer card face 124 and a first inner card face 126, and the back panel 120 can include a second inner card face 128 and a second outer card face (e.g., see the second outer card face 130 in FIG. 2 and this is obscured from view in FIG. 1, on the opposite side of the back panel 120 as the second inner card face 128). The first outer card face 124 can form a front of the greeting card blank 110, and the second outer card face can form a back of the greeting card blank 110.

In some examples, the first outer card face 124 can include a graphic 132 (e.g., heart graphic in FIG. 1 is an example and the graphic 132 could be any of a variety of different graphics, such as letters, numbers, symbols, pictures, etc.). In addition, the second inner card face 128 of the back panel 120 can include one or more blank portions 134 that can be customized with a graphic (e.g., a graphic selected by a customer purchasing the greeting card blank 110 from a greeting card retailer). As such, the graphic 132 on the first outers card face 124 and the 3D card element 116 can be generic or common across multiple cards, and any of the cards can be customized with a different graphic printed in the portion 134 (e.g., an array of cards with a same graphic 132 and same 3D card element 116 and with a customized graphic in portion 134).

In addition, the greeting card blank 110 can include a protective panel 138 that is hingedly coupled to the front panel 118 by a second fold 140, and in examples, the 3D card element 116 is coupled to at least one of the front panel 118 or the protective panel 138. For example, the protective panel 138 can include a third inner card surface 137, and the 3D card element 116 can be coupled to at least one of the first inner card surface 126 or the third inner card surface 137. The front panel 118 and the protective panel 138 are movable between a closed configuration, in which the front panel 118 and the protective panel 138 are folded towards one another and the 3D card element 116 is container therebetween (e.g., collapsed pop-up structure), and an open configuration, in which the front panel 118 and the protective panel 138 are splayed apart and away from one another and the 3D card element 116 is revealed (e.g. expanded pop-up structure). In examples, the first fold 122 and the second fold 140 can include a crease, hinge, or other living-hinge type structure permitting hinged rotation or movement of one panel relative to another panel. In examples, when the front panel 118 and the protective panel 138 are closed and the front panel 118 and the back panel 120 are closed, then the front panel 118 can form a front of the greeting card blank 110 and the back panel 120 can form a back of the greeting card blank 110. In FIG. 1, the 3D card element 116 is depicted as a sliceform-style, pop-up structure, and this is an example. In other examples, the 3D card element can include other types of pop-up structures, pockets, inserts, foldouts, gift-cards, gift-card holders, origami, or other greeting card elements that, when the front and protective panels are closed, are positioned between the first and third inner card surfaces 126 and 137 and create a thickness in addition to the first panel and the second panel.

In some examples, it can be useful to construct or assemble the greeting card blank 110 (e.g., with the 3D card element 116 coupled) prior to printing on the back panel 120 (e.g., on an inner face of the back panel 120). For instance, a greeting card retailer can sometimes make available (e.g., for sale) a fully assembled greeting card blank 110, with the back panel 120 at least partially blank or empty to be printed on for customization or personalization by the card purchaser (or by the manufacturer, retailer, or other entity). In some instances, the fully assembled greeting card blank 110 can include the graphic 132 and the 3D card element 116, which can be common across an array of already fully assembled greeting card blanks that are then each customized with a different graphic in the portion 134. For efficiency and timeliness, it can be useful to have the greeting card blank 110 ready for printing (e.g., via the printer 112), such that after the purchase of the greeting card blank 110 (e.g., online purchase or in-store purchase), the card can be ready to send or gift after the back panel 120 is printed. In at least one example, a greeting card retailer can receive (e.g., from a computing device of a card purchaser) a digital image to be used to customize the greeting card blank 110. For instance, the card purchaser can use a camera on their computing device to record a digital image (e.g., of their signature or some other sentiment) and can send the digital image to the greeting card retailer for printing (via the printer 112) on the back panel 120. These examples are in contrast to other systems, that might wait to assembly the greeting card (e.g., by attaching the 3D card element 116) until after the card is printed (e.g., by printing on the back panel), and these other systems (that are contrary to some examples of the present disclosure) can be slower and less efficient, since the 3D card element 116 must still be attached after the back panel 120 is printed.

FIG. 1 presents various graphical representations and schematic type depictions associated with printing. For example, FIG. 1 depicts a schematic view of a printer 112a as the printer 112a can be oriented respective to the greeting card 110b. In addition, FIG. 1 depicts a schematic view of a printer 112b as the printer 112b can be oriented and/or laid out with respect to the greeting card 110c, and the greeting card 110c is essentially a bottom elevation view of the greeting card 110b. In examples, various printers can be used (e.g., digital, laser, inkjet, or other automated printer types), and in one example, the printer 112a/includes a card feeder 142, which can include rollers, guides, etc. for moving or conveying a card (e.g., the greeting card blanks 110b and 110c) through the printer 112a/b (e.g., when fed in the direction of arrow 144). The printer 112a/b can print various graphics on the card, and in some example, the graphic can represent a digital image provided by a card purchaser (e.g., sent from a mobile device or other computing device of the card purchaser) or by another digital image source (e.g., manufacturer, retailer, etc.).

In examples, a graphic can be printed on the back panel 120 of the greeting card blank 110 (e.g., in the portion 134 of the second inner card face 128), while reducing the likelihood that the 3D card element 116 is damaged (or interferes with printer components) and/or providing a consistent and evenly printed graphic. For instance, FIG. 1 depicts the front panel 118 and back panel 120 are open, and the front panel 118 and protective panel 138 are closed, with the 3D card element 116 contained between the front panel 118 and the protective panel 138 (e.g., collapsed pop-up structure). In addition, the second fold 140 is relatively further along in the direction of the feed 144 (e.g., passing the print head first), as compared with free edges of the protective panel that are not directly attached to another panel (e.g., free edge 141). In addition, when the card 110d is fed into the printer 112b in the direction of the arrow 144, the protective panel 138 protects the contained 3D card element 116 from interference with printer 112b components. For instance, the orientation of the protective panel 138 and the fold 140 can increase the likelihood that the protective panel 138 will remain closed when moving through the printer 112 and being manipulated, conveyed, and automatically fed via the card feeder 142. That is, the orientation of the second fold 140 further along in the direction of the feed 144, relative to at least some other free edges of the protective panel 138 can decrease the likelihood of one of the edges (e.g., 141) interfering with a printer component (e.g., card feeder 142).

In examples, the present disclosure can include other printing techniques, and referring to FIG. 1B, a reference view is provided that is similar to the printing schematics in FIG. 1. In at least some examples of the present disclosure, the greeting card 110e can be oriented 90 degrees, relative to the orientation in FIG. 1. As depicted, the second fold 140 is further along in the direction of the feed 144, relative to at least some other free edges of the protective panel 138, and as such, when the feeder elements 142 contact the protective panel 138, the protective panel 138 is biased to a closed position, which protects the 3D card element (obscured from view in FIG. 1B) from interference with components of the printer 112a. In some examples, the orientation of the card 110 (when printing) can at least partially depend on the dimensions and setup of the printer 112a/b (e.g., guide widths). For example, in at least one example, where the print head is positioned relatively further away or later in the feed direction (e.g., relative to other printer components), the back panel can be fed into the printer before the front panel and the protective panel, in which case, the second fold connecting the front panel to the protective panel can be adjacent the first fold.

In examples, once the card 110b is in position, the print head 146 can print a graphic on the back panel 120 (e.g., in the portion 134), and because the back panel 120 is independent of the 3D card element 116 (e.g., a single layer of material), the second inner card face 128 of the back panel 120 provides a relatively flat and uniform surface on which to print. In contrast, if a card is constructed or oriented such that the print head 146 prints on a protective panel or some other panel covering a 3D card element (e.g., multi-layers of material), then the printed-on surface can be uneven, rounded, angled, etc., which can negatively affect the print quality. Once printing operations are completed, the printed greeting card 114 can include a graphic 152 (FIG. 1) printed on the second inner card face 128 of the back panel 120. The graphic 152 can include, among other things, text, letters, numbers, symbols, pictures, etc. In addition, the graphic 152 can include a representation of a digital image provided by a customer purchasing the card from a greeting card retailer.

In at least one example, the printed greeting card 114 can provide, for a card recipient, a multi-stage opening experience. For instance, a first stage of the experience can include presentation of at least the graphic 132 on the front panel 118. A second stage of the experience can include, when the front panel 118 is opened and the protective panel 138 remains closed, a presentation of the graphic 152, which could have been customized by the customer purchasing the card. Further, a third stage of the experience can include, when the protective panel 138 is opened, presentation of the 3D card element (e.g., pop-up structure moving to, and presenting in, an expanded state), which can be experienced together with the presentation of the graphic 152 on the second inner card face 128.

FIGS. 1, 1B, and 2 illustrate an example in which the second fold 140 is oriented substantially parallel with the first fold 122. In other examples, the second fold that hingedly couples the front panel of a card to a protective panel of a card can include, relative to the first fold, other orientations. For example, referring to FIG. 3, an example is depicted that includes a greeting card blank 210. In accordance with examples of the present disclosure, the greeting card blank 210 includes a 3D card element 216 and various features that facilitate printing on the greeting card blank 210 (e.g., via the printer 212), regardless of potential uneven surfaces in the greeting card blank 210 that can result from the 3D card element 216 or potential interference between the 3D card element 216 (or other parts of the card) and the printer 212.

In some examples, the greeting card blank 210 can include (similar to the greeting card blank 110) a front panel 218 and a back panel 220 that are hingedly coupled to one another along a first fold 222. The front panel 218 and the back panel 220 are movable between a closed configuration, in which the front panel 218 and back panel 220 are folded (along the first fold 222) towards one another, and an open configuration, in which the front panel 218 and the back panel 120 are splayed (via the first fold 222) apart and away from one another. In addition, the front panel 218 can include a first outer card face 224 and a first inner card face 226, and the back panel 220 can include a second inner card face 228 and a second outer card face (e.g., see the second outer card face 230 in FIG. 4 and this is obscured from view in FIG. 3, on the opposite side of the back panel 220 as the second inner card face 228). The first outer card face 224 can form a front of the greeting card blank 210, and the second outer card face can form a back of the greeting card blank 210.

In some examples, the first outer card face 224 can include a graphic 232 (e.g., heart graphic in FIG. 3 is an example and the graphic 232 could be any of a variety of different graphics, such as letters, numbers, symbols, pictures, etc.). In addition, the second inner card face 228 of the back panel 220 can include one or more blank portions 234 that can be customized with a graphic (e.g., a graphic selected by a customer purchasing the greeting card blank 110 from a greeting card retailer). As such, the graphic 232 on the first outer card face 224 and the 3D card element 216 can include generic or common features that are the same across multiple cards (e.g., across an array of cards), and each of the versions across the multiple/array can be customized with a different graphic printed in the portion 234.

In addition, the greeting card blank 210 can include a protective panel 238 that is hingedly coupled to the front panel 218 by a second fold 240, and in examples, the 3D card element 216 is coupled to at least one of the front panel 218 or the protective panel 238. For example, the protective panel 238 can include a third inner card face 237, and the 3D card element 216 can be coupled to at least one of the first inner card face 226 or the third inner card face 237. The front panel 218 and the protective panel 238 are movable between a closed configuration, in which the front panel 218 and the protective panel 238 are folded towards one another and the 3D card element 216 is contained therebetween (e.g., collapsed pop-up structure), and an open configuration, in which the front panel 218 and the protective panel 238 are splayed apart and away from one another and the 3D card element 216 is revealed. In examples, the first fold 222 and the second fold 240 can include a crease, hinge, or other living-hinge type structure permitting hinged rotation or movement of one panel relative to another panel. In examples, when the front panel 218 and the protective panel 238 are closed and the front panel 218 and the back panel 220 are closed, then the front panel 218 can form a front of the greeting card blank 210 and the back panel 220 can form a back of the greeting card blank 210.

In some examples (similar to described with respect to FIG. 1 and the greeting card blank 110), it can be useful to construct or assemble the greeting card blank 210 (e.g., with the 3D card element 216 coupled) prior to printing (e.g., digital, laser, inkjet or other automated printing) on the back panel 220 (e.g., on an inner face of the back panel 220). For instance, a greeting card retailer can sometimes make available (e.g., for sale) a fully assembled greeting card blank 210, with the back panel 220 at least partially blank or empty to be automatedly printed on for customization or personalization by the card purchaser (e.g., printed using the printer 112). In some instances, the fully assembled greeting card blank 210 can include the graphic 232 and the 3D card element 216, which can be common across an array of already fully assembled greeting card blanks that are then each customized (via the printer 112) with a different graphic in the portion 234. For efficiency and timeliness, it can be useful to have the greeting card blank 210 ready for printing, such that after the purchase of the greeting card blank 210 (e.g., online purchase or in-store purchase), the card can be ready to send or gift after the back panel 220 is printed (e.g., via the printer 112). In at least one example, a greeting card retailer can receive (e.g., from a computing device of a card purchaser) a digital image to be used to customize the greeting card blank 210. For instance, the card purchaser can use a camera on their computing device to record a digital image (e.g., of their signature or some other sentiment) and can send the digital image to the greeting card retailer for printing on the back panel 220. These examples are in contrast to other systems, that might wait to assembly the greeting card (e.g., by attaching the 3D card element 216) until after the card is printed (e.g., by printing on the back panel), and these other systems (that are contrary to some examples of the present disclosure) can be slower and less efficient, since the 3D card element 216 must still be attached after the back panel 220 is printed.

FIG. 3 presents various graphical representations and schematic type depictions associated with printing. For example, FIG. 3 depicts a schematic view of a printer 212a as the printer 212a can be oriented respective to the greeting card 210b. In addition, FIG. 3 depicts a schematic view of a printer 212b as the printer 212b can be oriented and/or laid out with respect to the greeting card 210c, and the greeting card 210c is essentially a bottom elevation view of the greeting card 210b. In examples, the printer 212a/b can be similar to the printer 112a/b and can include a card feeder 242 (e.g., rollers, guides, etc.), a feed direction 244, and a print head 246. In examples, a graphic can be printed on the back panel 220 of the greeting card blank 210b/c (e.g., in the portion 234 of the second inner card face 228), while reducing the likelihood that the 3D card element 216 is damaged (or interferes with printer components) and/or providing a consistent and evenly printed graphic. For instance, FIG. 3 depicts the front panel 218 and back panel 220 can be open, and the front panel 218 and protective panel 238 can be closed, with the 3D card element 216 contained therebetween. In addition, the second fold 240 can be at least close to or even with (and in some examples further along) in the direction of the feed 244, as compared with free edges of the protective panel that are not directly attached to another panel (e.g., free edge 241). In addition, when the card 210d is fed into the printer 212b in the direction of the arrow 244, the protective panel 238 protects the contained 3D card element 216 from interference with printer 212b components. For instance, the orientation of the protective panel 238 and the fold 240 can increase the likelihood that the protective panel 238 will remain closed when moving through the printer 212 and being manipulated, conveyed, and automatically fed via the card feeder 242. That is, the orientation of the second fold 240 relatively further along in the feed direction, relative to at least some other free edges (e.g., a free edge that is opposite the second fold 240) of the protective panel 238 can decrease the likelihood of one of the edges interfering with a printer component (e.g., card feeder 242).

In examples, the present disclosure can include other printing techniques, and referring to FIG. 3B, a reference view is provided that is similar to the printing schematics in FIG. 3. In at least some examples of the present disclosure, the greeting card 210e can be oriented 90 degrees, relative to the orientation of the greeting card 210b in FIG. 3. As depicted, the second fold 240 is further along in the feed direction, relative to at least some other free edges of the protective panel 238, and as such, when the feeder elements 242 contact the protective panel 238, the protective panel 138 is biased to a closed position, which protects the 3D card element (obscured from view in FIG. 3B) from interference with components of the printer 212a. In some examples, the orientation of the card 210 (when printing) can at least partially depend on the dimensions and setup of the printer 212a/b (e.g., guide widths).

In examples, once the card 210b is in position, the print head 246 can print a graphic on the back panel 220 (e.g., in the portion 234), and because the back panel 220 is independent of the 3D card element 216 (e.g., the back panel 220 on which the printed graphic is received is a single layer of material), the second inner card face 228 of the back panel 220 provides a relatively flat and uniform surface on which to print. In contrast, if a card is constructed or oriented such that the print head 246 prints on a protective panel or some other panel covering a 3D card element (e.g., the printed on surface is multi-layer), then the printed-on surface can be uneven, rounded, angled, etc., which can affect the print quality or appearance. Once printing operations are completed, the printed greeting card 214 can include a graphic 252 printed on the second inner card face 228 of the back panel 220. The graphic 252 can include, among other things, text, letters, numbers, symbols, pictures, etc. In addition, the graphic 252 can include a representation of a digital image provided by a customer purchasing the card from a greeting card retailer. Similar to the greeting card 114, the printed greeting card 214 can provide for a card recipient, a multi-stage opening experience.

FIGS. 1, 1B, and 2 (and the related descriptions) are associated with a card in which the second fold 140 is oriented parallel to the first fold 122, and FIGS. 3, 3B, and 4 (and the related descriptions) are associated with a card in which the second fold 240 is oriented perpendicular to the first fold 222. In some examples, a protective panel can be hingedly coupled to the first panel by a fold oriented at any angle relative to the first panel, such that the fold is relatively further along in the feed direction (e.g., relative to other portions/edges of the protective panel) when the card is fed into a printer. In some examples, a card can have multiple protective panels that overlay the first panel in the closed configuration, and the associated folds that hingedly couple the protective panels to the first panel can include similar orientations (e.g., two or more perpendicular, such as one on a top edge and one on a bottom edge) or multiple varied orientations.

In some examples, the card can include one or more tabs and/or corners that insert into slots to retain the protective panel closed (e.g., while printing), until it is desired to open the protective panel (e.g., during the card-opening experience). For example, a tab extension could protrude from the edge 139 and insert into a slot located in the front panel 118 and/or the back panel 120 (e.g., a similar tab and slot construction can be included in the card 210). In addition, the front panel or the back panel can include angled slots to receive (e.g., and temporarily hold) corners of the protective panel, such as when the protective panel is closed and is containing or covering the 3D card element. In at least some examples, the card can include one or more photo corners (e.g., coupled to the front panel or back panel), and portions (e.g., corners) of the protective panel can releasably insert into the photo corners to help retain the protective panel in a closed configuration.

In at least one example, a greeting card and its associated panels can comprise one or more accordion fold structures. For example, an accordion fold structure can include a “W” configuration, which includes four panels (e.g., front most panel, rearmost panel, and two panels there between, and an accordion fold structure can include additional panels (e.g., five panels, six panels, etc.) following the accordion folding pattern. In addition, in some examples adjacent panels of the accordion fold structure can be coupled together to form a single panel, such as where the two middle panels of a W-configuration panel structure are coupled together to form a middle panel between the front most panel and the rearmost panel. In accordance with an example of the present disclosure, a 3D card element can be contained between panels of the accordion structure, while at least one of the other panels is configured to be automatedly printed. For example, referring briefly to FIG. 6, a greeting card blank 610 is depicted comprising an accordion fold structure, which includes a W configuration. In accordance with examples of this disclosure, the greeting card blank 610 can include a 3D card element and is conducive to printing via a printer 612. For example, the greeting card blank 610 includes a first panel 614, a second panel 616, a third panel 618, and a fourth panel 620. In accordance with an example of the present disclosure, a 3D card element can be contained between the first panel 614 and the second panel 616, and the fourth panel 620 can include a portion 622 for receiving a graphic via the printer 612, which the 3D card element is protected from interference with printer components (e.g., 624). For example, the greeting card 610 can be fed into the printer 612 in the feed direction 626, such that the 3D card element is contained between the first panel 614 and the second panel 616, and based on the third panel 618 and fourth panel 620 being splayed open, the portion 622 is facing towards the print head 628. In this sense, the second panel 616 and the third panel 618 operation similar to a protective panel, as described in other aspects of this disclosure. In addition, in some examples, the second and third panels 616 and 618 can be coupled to one another (e.g. along the faces that face towards one another) to form a unitary panel, such that the greeting card blank 610 can include a three panel, booklet style structure, in which the panels extend outward from a common biding area.

In at least some examples, the front panel and the back panel can be coupled to a common binding area, which can connect one or more additional panels, such as the protective panel. In this respect, the front panel, the back panel, and the one or more additional panels can all attach to or near the common binding area, and can be fed into the printer in a manner that biases the protective panel over a 3D card element contained there under. In some examples, panels connected to the greeting card at a common binding area can be similar to a booklet form, in which the 3D card element is contained between two panels of the booklet.

In at least one example, the present disclosure includes an array of cards that include a copy of the same graphic on the front of the card, a copy of the same 3D card element (e.g., pop-up structure) contained between the front panel and a protective panel, and a different, custom graphic that is automatedly printed on the inside of the back panel. For example, the array could include multiple copies of the greeting card blank 110 or multiple copies of the greeting card blank 210, and each of the copies can include a different graphic that is printed on the inside of the back panel (e.g., a graphic that is a copy of a digital image provided by a card purchaser, by a retailer, by a manufacturer, or by another source). In this respect, examples of the present disclosure can efficiently manufacture an array of greeting cards providing a multi-stage card-opening experience that is also customized (e.g., customized based on the card purchaser or retail consumer).

Referring to FIG. 5, a flow diagram is depicted that includes operations or steps in accordance with a method 500 of the present disclosure. In addition, pictorials are provided in FIG. 5 in association with each of the operations or steps to help illustrate one or more examples related to this description, and the claims are not limited by the pictorials. In at least one example, the method 500 can include, at step 502, forming, as part of a greeting card blank, a first fold between a front panel and a back panel. For example, in association with a greeting card blank 504, a fold 506 can be created between the front panel 508 and the back panel 510, or in association with a greeting card blank 512, a fold 514 can be created between the front panel 516 and the back panel 518. The front panel 508 and 516 can comprise a first outer card face (e.g., 124 or 224), which comprises a front of the greeting card, and can comprises a first inner card face 509 and 517. In addition, the back panel 510 and 518 can include a second outer card face (e.g., 130 or 230), which comprises a back of the greeting card, and can comprises a second inner card face 520 and 522. In some examples, the second inner card face 520 or 522 can include a portion 521 or 523 configured to be printed on by an automated printer.

In at least some examples, the method 500 can include, at 524, forming, as part of the greeting card blank, a second fold between the front panel and a protective panel. For example, in the greeting card blank 504, a second fold 526 can be formed between the front panel 508 and a protective panel 528; and in the greeting card blank 512, a second fold 530 can be formed between the front panel 516 and a protective panel 532. In at least some examples, the protective panel 528 or 532 hinges via the second fold 526 or 530 between a closed position (e.g., depicted in FIGS. 1 and 3), in which the protective panel 528 or 532 overlays the front panel 508 or 516, and an open position (e.g., depicted in FIG. 5), in which the protective panel 528 or 532 is splayed outward relative to the front panel 508 or 516.

In at least some examples, the method 500 can include, at 534, arranging a three-dimensional (3D) structure with the greeting card, such that the 3D card element is contained between the front panel and the protective panel when the protective panel is closed. For example, a 3D card element 536 (e.g., pop-up structure) can be coupled to the front panel 508 or the protective panel 528, or a 3D card element 538 (e.g., pop-up structure) can be coupled to the front panel 516 or the protective panel 532. FIG. 5 illustrates an example in which the three-dimensional structure includes a pop-up structure (e.g., slice-form, pop-up structure), and in other examples, the three-dimensional structure can include other types of pop-up structures, fold-outs, origami structures, pockets, inserts, and the like. In at least some examples, the 3D card element 536 or 538 can be contained between the front panel 508 or 516 and the protective panel 528 or 532 when they are in the closed position.

In at least some examples, the method 500 can include, at 540, feeding, with the protective panel in the closed position, the greeting card into a printer. For example, the pictorial associated with step 540 illustrates a printer 542 and a feed direction 544. In addition, the greeting card 504 includes the protective panel 528 closed (with the 3D card element 536 contained there beneath) and the greeting card 504 can be fed in the direction 544, such that the print head 546 can print a graphic in the portion 521. Similarly, the greeting card 512 includes the protective panel 532 closed (with the 3D card element 538 contained there beneath) and the greeting card 512 can be fed in the direction 544, such that the print head 546 can print a graphic in the portion 523.

In examples, the method 500 can include, at 548, printing, on the second inner card face and via the printer, a graphic. For example, a graphic 550 can be printed on the second inner card face 520 of the card 504, or a graphic 552 can be printed on the second inner card face 522 of the card 512.

This detailed description is provided in order to meet statutory requirements. However, this description is not intended to limit the scope of the invention described herein. Rather, the claimed subject matter may be embodied in different ways (including those not shown), to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof. Alternative means of implementing the aforementioned can be completed without departing from the scope of the claims below. Certain features and sub-combinations are of utility, may be employed without reference to other features and sub-combinations, and are contemplated within the scope of the claims.

What is claimed is:

1. A system comprising:
a plurality of preassembled greeting card blanks each of which comprises:
a front panel comprising a first outer card face, which comprises a front of the preassembled greeting card blank, and comprising a first inner card face;
a back panel hingedly connected to the front panel along a first fold and comprising a second outer card face, which comprises a back of the preassembled greeting card blank, and comprising a second inner card face;
a protective panel hingedly connected to the front panel along a second fold, the protective panel being movable, by hinging via the second fold, between a closed position and an open position, wherein, in the closed position, the protective panel overlays the front panel, and in the open position, the protective panel is splayed outward and apart from the front panel; and
a 3D card element affixed to the preassembled greeting card blank, the 3D card element being contained between the front panel and the protective panel when the protective panel is in the closed position; and
a printer comprising:
a card feeder that receives each preassembled greeting card blank with the protective panel in the closed position so as to contain the 3D card element between the front panel and the protective panel and the second inner card face oriented towards a print head, wherein the card feeder receives the front panel and the protective panel of each preassembled greeting card blank before the back panel, and wherein the card feeder receives the second fold of each preassembled greeting card blank before an edge of the protective panel opposite the second fold; and
the print head automatedly printing, while the protective panel is in the closed position, a custom graphic on the second inner card face of each preassembled greeting card blank, wherein the custom graphic is a printed representation of a digital image provided by a card purchaser for each respective preassembled greeting card blank.

2. The system of claim 1, wherein the second fold is parallel to the first fold.

3. The system of claim 1, wherein:
the 3D card element is a pop-up structure affixed to at least one of the first inner card face or the protective panel; and
the pop-up structure is collapsed when the protective panel is in the closed position.

4. The system of claim 1, wherein the print head prints a first graphic comprising a printed representation of a first digital image on a first preassembled greeting card blank and a second graphic comprising a printed representation of a second digital image on a second preassembled greeting card blank, the second digital image being different from the first digital image.

5. The system of claim 4, wherein the first digital image is received from a first computing device of a first card purchaser and the second digital image is received from a second computing device of a second card purchaser that is different from the first card purchaser.

6. The system of claim 1, wherein the front panel, the back panel, and the protective panel comprise an accordion fold structure.
